(19) United States
(12) Patent Application Publication
(10) Pub. No.: US 2010/0202365 A1
(43) Pub. Date: Aug. 12, 2010

(54) MODULAR COMMUNICATIONS APPARATUS AND METHOD

(76) Inventors: BRITT B. BAMBIC, Boise, ID (US); Casimir E. Lawler, JR., Boise, ID (US)

Correspondence Address: DYKAS, SHAVER & NIPPER, LLP, P.O. BOX 877, BOISE, ID, 83701-0877, US

(21) Appl. No.: 12/767,619

(22) Filed: Apr. 26, 2010

Related U.S. Application Data
(63) Continuation of application No. 11/428,793, filed on Jul. 5, 2006, now abandoned.
(60) Provisional application No. 60/725,172, filed on Oct. 11, 2005.

(51) Int. Cl. H04W 88/00

(52) U.S. Cl. 370/328

(57) ABSTRACT

A modular device for providing wireless services and a network of such devices.

### PRIORITY/CROSS-REFERENCE TO RELATED APPLICATIONS

This application is a continuation application of, and claims the benefit of, application Ser. No. 11/428,793, filed on Jul. 5, 2006, which claimed the benefit of provisional application Ser. No. 60/725,172, filed on Nov. 11, 2005, the disclosures of which are incorporated herein by reference.

### FIELD OF THE INVENTION

The invention relates generally to a device and method using the apparatus for wireless communications, and more particularly to a modular device for providing a variety of wireless services in a local service area and for communicating with more distant service, a network of such devices, and a method of using such devices.

### BACKGROUND OF THE INVENTION

Increasing use of mobile voice and data communication devices, such as personal digital assistants (PDAs), portable computers, cell phones, and portable music players (often called MP3 players), along with increasing demand for Internet connections in fixed locations, has driven increasing demand for wireless services. Users are also demanding higher quality connections: faster communications, pervasive geographic coverage, and constant availability.

Communication is the process of exchanging information via a set of common protocols. In the past, it was common to separately classify voice, video and digital information communication. With the rise of modern, high-speed protocols and equipment, voice and video are often digitized and transmitted as digital data. In the context of this document, communication refers to all types of data, including analog, digital, voice, video, and general numerical and text information, unless otherwise stated.

Communications can occur electronically via wired or wireless means. Wired communications generally refers to communications methods requiring cables or cords; for example, telephone lines, power lines, coaxial cables, or fiber optic cables. In contrast, wireless communications occur without the use of cables or cords. Wireless communications may employ electromagnetic waves, including frequencies in the radio, infrared light, and visible light bands.

Wireless services come in many forms; for example, cell phones and wireless networks, among others. Cell phones currently provide voice communications and limited non-voice communications, although the non-voice capability is rapidly increasing. Wireless networks link together groups of communication devices, computers, or other networks without requiring a wired connection between devices.

Cellular communication providers generally have proprietary networks, servicing only those phones that are registered with the network. The dialogue carrying voice communications between a cell phone handset and a cell phone access point is a stream of digitized audio or an analog audio signal. Published cellular communications standards include Advanced Mobile Phone System (“AMPS”), an analog standard; IS-54 and its successor IS-136, digital standards often called Digital AMPS, “D-AMPS,” or sometimes imprecisely “TDMA”; Global System for Mobile Communications (“GSM”); IS-95, also often called “CDMA”; IS-2000, also called “CDMA2000®” and a successor to IS-95, and W-CDMA. IS-54, IS-95, IS-36, and IS-2000 all refer to standards published by the Telecommunications Industry Association.

Devices that communicate via cellular communication channels are commonly referred to as “subscriber units,” and not only include cell phones, but also include PDAs, notebook computers, and other electronic equipment capable of communicating via a cellular communications network and complying with one or more cellular communications standards.

Wireless networking protocol standards include Wi-Fi®, Wi-Max®, Home-RF®, HiperLAN, and Bluetooth®, among others. Networks may be wirelessly bridged, that is, connected together. A bridge generally means a device that connects two networks or two segments of the same network that use the same or compatible protocol.

Wi-Fi®, short for wireless fidelity, refers to network products and communications complying with the IEEE 802.11 standards, and includes 802.11, 802.11a, 802.11b, and 802.11g. Wi-Fi® employs microwave radio frequency carriers: in the 2.4 GHz band for 802.11, 802.11b, and 802.11g communications, and the 5.0 Ghz band for 802.11a communications. Communications speeds vary from 11 megabits/sec (Mbs) for 802.11b to 54 Mbs for 802.11a and g.

Wi-MAX®, short for Worldwide Interoperatibility for Microwave Access, refers to network products and communications complying with the IEEE 802.16 standards, including 802.16 and 802.16a. IEEE 802.16 compliant networks can generally be bridged and routed to other IEEE 802.x compliant networks, including Wi-Fi®. Wi-MAX® employs microwave radio frequency carriers in the 2-11 GHz range for 802.16a communications, and 10-66 GHz range for 802.16 communications. Wi-MAX® is intended to support metropolitan area networks, large networks spanning a campus or a city, and to replace wired broadband communication services, such as DSL and digital cable. Wi-Max® supports theoretical data rates up to 70 Mbps.

HiperLAN is a term referring to network products and communications complying with ETSI standards EN3000652 and ETS300836. It is similar in functionality to Wi-Fi® standards and is used primarily in Europe. HiperLAN/1 uses the 5 GHz band and supports speeds up to 20 Mbps; HyperLAN/2 uses the 5 GHz band and supports speeds up to 54 Mbps.

Bluetooth® refers to network products and communications complying with IEEE 802.15.1, a standard originally designed to support personal wireless networks. Bluetooth® uses a 2.54 GHz carrier, and data rates depend on range and the power class of the product. Bluetooth® is often included in cell phones, and is appearing on other mobile devices, such as MP3 audio players and personal digital assistants (“PDAs”).

HomeRF® refers to a standard developed by the HomeRF Working Group designed to support personal wireless networks. It uses the 2.4 GHz band at up to 10 Mbps.

An access point is a hardware device that acts as hub for users of wireless devices to connect to a network. Access points are usually employed to connect to a wired network, meaning a network having at least some nodes interconnected by physical wires. An access point typically employs one or more wireless services and is usually associated with at least one antenna.

Communications in certain bands is subject to signal degradation, either from interference by other users of the same frequencies, or from multipath distortion. For example, Wi-Fi® shares the 2.4 GHz band with a variety of unlicensed users, ranging from Bluetooth® users, HomeRF® networks, microwave ovens, and cordless phones. Multipath signals occur when physical objects reflect or refract a wireless signal, leading to multiple copies of the signal arriving at the receiver and distorting the resulting received signal. One solution to reduce the effects of interference and multipath distortion is to install a large number of relatively low power access points or antennae.

Most wireless services are at frequencies that require the receiver to be within a line of sight to the transmitter; in other words, the path between the receiver and transmitter may not be obstructed by the horizon, significant terrain, or large objects. When a receiver is within a line of sight to the transmitter, it is said to be in view of the transmitter. In many areas, particularly cities, coverage is blocked by buildings, terrain, or foliage. To obtain pervasive geographic coverage and to overcome interference, providers generally must install many access points. Raising antennae by the use of towers increases line of sight coverage, but tall towers, particularly cell phone towers, are often unsightly and generate objections from neighbors. Decorating or camouflaging towers may reduce objections, but at additional cost. Depending on the service used, buildings and walls may block signals, requiring even more antennae to provide uninterrupted coverage. Spacing between antennae can be as little as 500 feet.

Each wireless service provider tends to install a network independent of other providers in a given geographic area. Multiple, overlapping networks lead to a multiplicity of antennae, towers, wiring, and other hardware with associated expenses for acquisition, installation, and maintenance. Wired connections to a network are often not available in the vicinity of the best location for an access point. Wired power is also often unavailable or intermittent.

For communications over long distances or to a separate service, a user often must communicate through a telecommunication carrier, an organization that provides bulk communication services. Carrier charges vary depending on the type, quality, availability, and throughput provided by the service. Telecommunication carriers include long distance telephony carriers, Internet service providers, and data communication providers.

To place antenna and access points, service providers traditionally conducted detailed site surveys to determine the location of obstructions, access to power, access to a wired network, and the minimum number of access points to achieve the required level of coverage. Performing such surveys is generally expensive, time consuming, and requires trained personnel. A minimum number of access points save both hardware and connection costs, but increases the cost of surveys, planning, and in some cases, installation. If additional structures are erected near the access point or antennae, the site must often be re-surveyed and additional antennae installed to correct coverage.

Network managers must be able to send commands to the access points and query status reliably. There is a need for this capability even if the node is unable to connect to a network; for instance, when the node is first installed and it is unable to connect to the network because wireless communications is blocked. Ensuring that a newly installed access point is available to the network requires trained installers.

It has become increasingly common for cities to place security cameras at street corners and other public places in need of monitoring. These cameras must communicate with a central monitoring agency. Likewise, cities often deploy networks of air quality monitoring systems that must be able to communicate to a central agency.

On the whole, current wireless service solutions result in a significant number of overlapping and duplicative networks, with little synergy. Highly trained personnel are required to install and maintain these systems.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features of the present invention will become readily apparent to those skilled in this art from the following detailed description describing only the preferred embodiment of the invention, simply by way of illustration of the best mode contemplated by carrying out this invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view showing an embodiment of a beehive having several modules installed.

FIG. 2 depicts the beehive embodiment of FIG. 1 mounted to a light pole.

FIG. 3 depicts one possible communications environment served by a beehive.

FIG. 4 is a schematic diagram of an embodiment of a network of multiple interconnected beehives.

FIG. 5 is a block diagram of embodiments of beehive modules interconnected by a bus.

FIG. 6 is a plan view of an embodiment of the provisioning module shown in FIG. 5.

FIG. 7 is a side view of an embodiment of the provisioning module shown in FIG. 6.

FIG. 8 is a plan view of an embodiment of the network access module shown in FIG. 5.

FIG. 9 is a plan view of an embodiment of the power module shown in FIG. 5.

FIG. 10 is a plan view of an embodiment of the wireless bridge module shown in FIG. 5.

FIG. 11 is a plan view of an embodiment of the monitor module shown in FIG. 5.

FIG. 12 is a plan view of an embodiment of the position module shown in FIG. 5.

FIG. 13 is a perspective view of an embodiment of the multimedia module shown in FIG. 5.

FIG. 14 is a plan view of an embodiment of the data storage module shown in FIG. 5.

FIG. 15 is a flowchart of an embodiment of a method for installing a beehive.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

Prior wireless service solutions tend to result in overlapping and duplicative networks, with concurrent high costs of planning, customization, installation, operation and maintenance.

Various embodiments of the present invention, allow low-cost customization of the elements of a wireless network, communication between interconnected networks to allow selection of a low-cost communication channel and communication in areas where some channels are blocked, installation of network elements without extensive site surveys and installation by low-skill workers.

In the following description and in the figures, like elements are identified with like reference numerals. The use of the word “or” denotes non-exclusive alternatives without limitation unless otherwise stated.

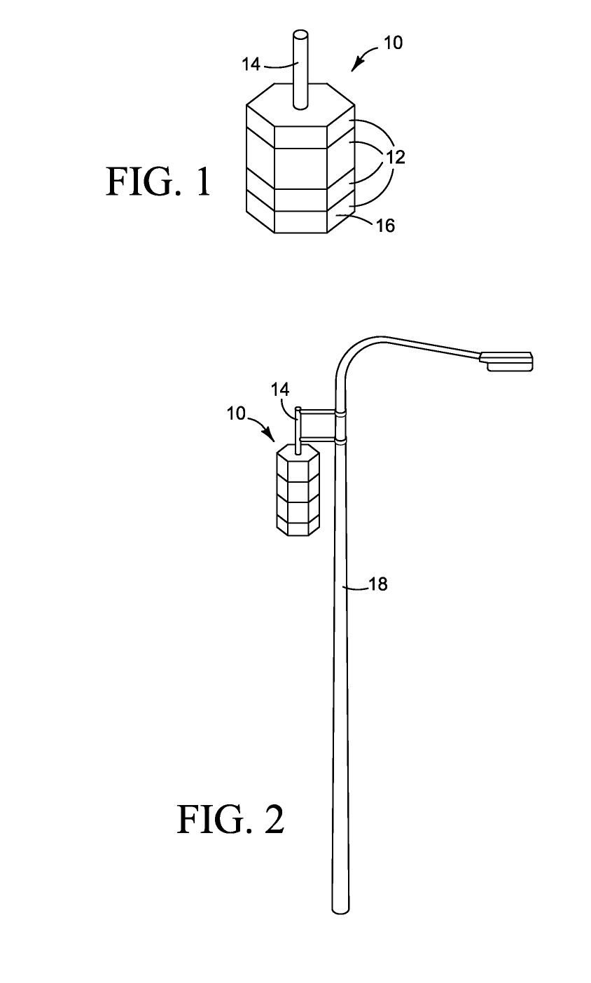

FIG. 1 illustrates a modular communications device 10 according to an embodiment of the invention. In this document, this and similar embodiments will be referred to as a “beehive.” In FIG. 1, beehive 10 is represented as a generally hexagonal planform; however, other shapes may be used depending on particular functional and aesthetic requirements of a given installation. Usable shapes include, without limitation, rectangular, circular, or octagonal planforms. Beehive 10 includes one or more modules 12, described in more detail below. Beehive 10 may be suspended from a hanger 14. In some applications, hanger 14 may be tubular, allowing power and communication wiring to be contained within hanger 14 for support and protection from the elements. In other embodiments, a cable, rigid rod, or any structure capable of supporting beehive 10 may be used. Each module 12 has a housing 16 which may be used to protect the interior from the elements or to present a pleasing appearance. In some modules, housing 16 may be made of material that does not interfere with electromagnetic radiation in the frequencies of the services provided by beehive 10. In other modules, housing 16 may be electromagnetically shielded to prevent interference between modules and with external devices.

FIG. 2 shows an example of a beehive 10 suspended from a light pole 18, illustrating that, depending on site requirements, beehive 10 may be suspended from a utility pole, including power, light, and telephone poles, from the side of a building, or suspended from a cable hung between fixed points.

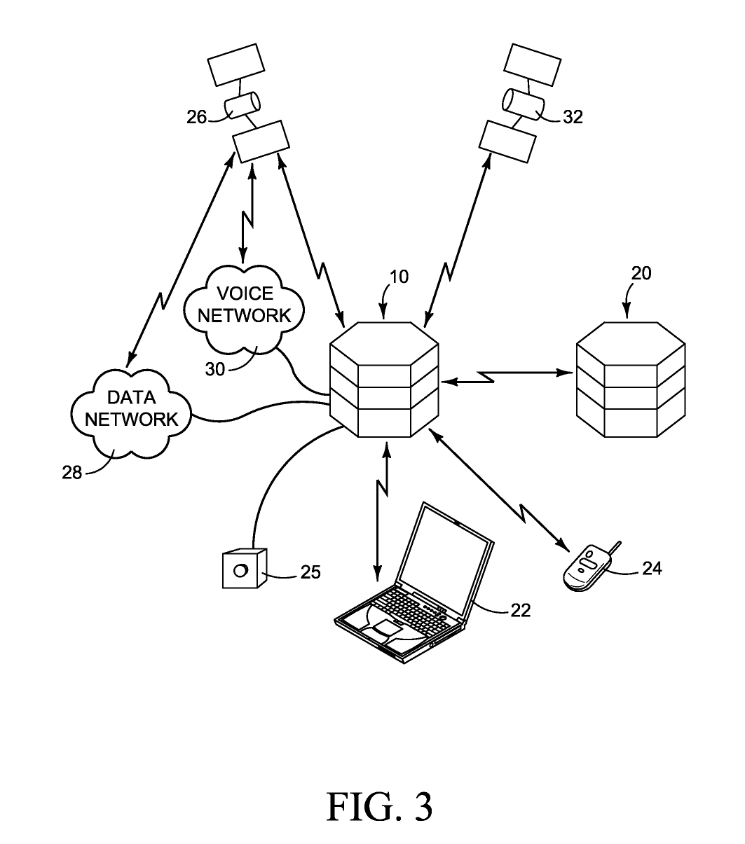

A beehive 10 may serve a variety of communication needs, depending in part on the type of modules 12 installed. Beehive 10 may be configured to serve wireless data networking needs, illustrated in FIG. 3 by a laptop computer 22. Beehive 10 may also serve mobile telephony needs, such as cell phones, illustrated in FIG. 3 by cell phone 24. Beehive 10 may be configured to provide emergency services communications, illustrated, but not limited to, a call box 25. Beehive 10 may route and aggregate telephone, data, emergency services or other communications to one or more communications satellites 26, which forwards the communications to a data network 28 or a voice network 30. Alternatively, beehive 10 may route and aggregate telephone or data communications to another beehive 20, data network 28 or voice network 30 directly via wired or wireless connections. While a single cell phone, laptop, voice network and data network is shown in FIG. 3, embodiments will support multiple instances of each of these users and networks. In an exemplary application, beehive 10 may communicate directly or indirectly with a first data network, the Internet; a second data network, a wide-area network for corporate communications; and a local area network supporting a campus.

In some embodiments, beehive 10 may select the best communications method to use, depending on site characteristics, availability, and costs. For example, at some sites wired connections to communication networks may be unavailable, requiring the use of satellite communications. At other sites, satellite connectivity may be blocked by adjacent buildings or electrical interference and wired communications is required. It is possible that both wired and satellite communications are available, but satellite may be the lowest cost communications method. Later, construction of new structures may block satellite communication, requiring beehive 10 to switch to wired communications. Selection of the best communications method may be performed by circuitry within beehive 10, or performed by an external agent that communicates with beehive 10 over a command channel. The command channel may be implemented over a wireless connection, for example to satellite 26 or another beehive 20, or via a wired connection. In some embodiments, the command channel is implemented using the data network 28. The command channel may also be used to communicate the status of beehive 10, including, without limitation, failure of a module, failure or degradation of a communication channel, and usage of wireless services.

An example of a command channel employing a non-geosynchronous satellite 32 is illustrated in FIG. 3. A non-geosynchronous satellite will typically have a constantly changing azimuth and elevation relative to beehive 10, allowing the satellite to repeatedly come into view of beehive 10 for a brief time, even when much of the view is blocked by structures. Some non-geosynchronous satellites are in low-earth orbit (“LEO”) orbiting between roughly 200-1200 km, and making a complete revolution around the earth in approximately 90 minutes. Others are in intermediate orbit, between LEO and geosynchronous orbit at 35,790 km, and orbital periods greater than 90 minutes. A constellation of intermediate orbit satellites is provided by a satellite navigation system, meaning a system designed primarily for determining one's precise location through the use of radio frequency signals transmitted by orbiting satellites.

Satellite navigation systems include the Global Positioning System (“GPS”) maintained by the United States; GLONASS, maintained by Russia; Beidou, maintained by China; and Galileo, currently being established by the European Union.

Beehive 10 may optionally communicate with non-geosynchronous satellite 32 in order to receive configuration commands and to send status information to a central command center. This optional capability is particularly useful when installing beehive 10 in a new location. It is very likely that non-geosynchronous satellite 32 will eventually travel into the view of beehive 10, even in the presence of man-made structures and geographical features that would otherwise block line-of-sight access to a geosynchronous satellite or ground-based wireless transceivers. Thus, beehive 10 may be installed in a new location without requiring the installers to carefully identify the best command channel, locate distant communication transceivers or precisely aim communications antennae. Instead, beehive 10 establishes a command channel via satellite 32 that is interrupted as satellite 32 passes in and out of view. While satellite 32 is in view of beehive 10, remote operators may configure beehive 10 to establish communications with communications satellite 26, beehive 20 or other remote communications service. Beehive 10 may also send and receive communications from laptop 22 or cell phone 24 through non-geosynchronous satellite 32.

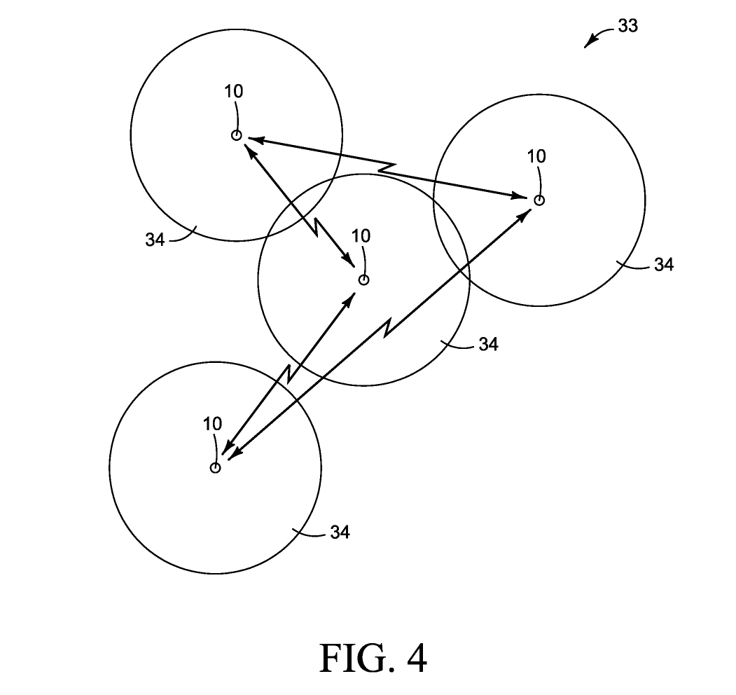

Multiple beehives 10 may optionally be linked to operate as a terrestrial communications network 33, as shown in FIG. 4. Each beehive 10 acts as a node in network 33. Rings 34 indicate approximate geographic regions of service coverage provided by the beehive 10 at the center of each ring 34. Maximum spacing between beehives depends on the type of wireless communication services provided, the presence of physical obstructions, and the desired quality of service. For Wi-Fi® in an unobstructed space, spacing may be as close as 500 feet. Each beehive 10 may aggregate communication services provided to users within its service region and pass the information to another beehive 10, which may then pass the information to yet another beehive 10, or forward the information to a non-network agent, such as a communication carrier, using wired connections or wireless connections, including via satellite. Network 33 allows coverage over a broad geographic area, without requiring wired or satellite connectivity at each location, simplifying planning and reducing installation costs. Any beehive 10 in network 33 may detect failures, degradation, or overcapacity of communication between it and another beehive 10 or between a beehive 10 and a telecommunication carrier, and may reroute communications to another beehive 10 accordingly.

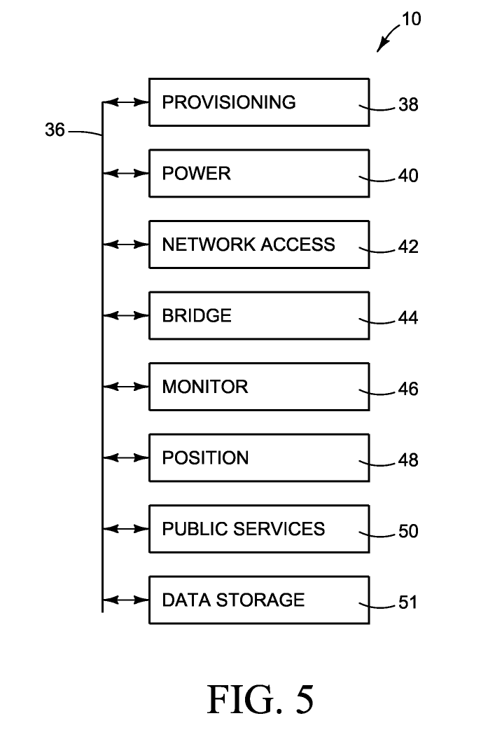

FIG. 5 is a schematic diagram of an embodiment, wherein each beehive 10 includes one or more modules 12 (FIG. 1) interconnected by a bus 36 that carries power and data signals. Modules include, without limitation, a provisioning module 38, a power module 40, a network access module 42, a bridge module 44, a monitor module 46, a position module 48, a multimedia module 50 or a data storage module 51. Not all modules are required, and modules are selected for inclusion in the beehive 10 depending on the particular service requirements of the installation site. The functions of each module may be combined or separated depending on requirements; for example, the functions of the power module 40 may be combined including in the provisioning module 38, which would be particularly useful if a particular network of beehives required that all beehives include both provisioning and power functions. The stacking order of the modules shown in FIG. 5 is generally arbitrary; modules may be installed in any order. In some applications, the order of the modules may be chosen consistent with the needs of the installation site; for example, the provisioning module may need to be place on the top of the stack to provide a clear field of view to its antennae.

Bus 36 may be a uniform, integrated bus, meaning that all data signals and power connections are collected together into a single bus and the interface to each module is identical. Alternatively, bus 36 may be segregated, so that data signals are separated from power connections. In a hybrid form of bus 36, data signals are carried over Ethernet connections, and power is transmitted over the Ethernet cables, commonly called “power over Ethernet”, or “PoE.” Whether bus 36 is integrated, segregated or hybrid, data signals may be transmitted using a proprietary protocol, or a standard protocol, including the internet protocol, “IP,” a network layer standard used by electronic devices to exchange data across a network.

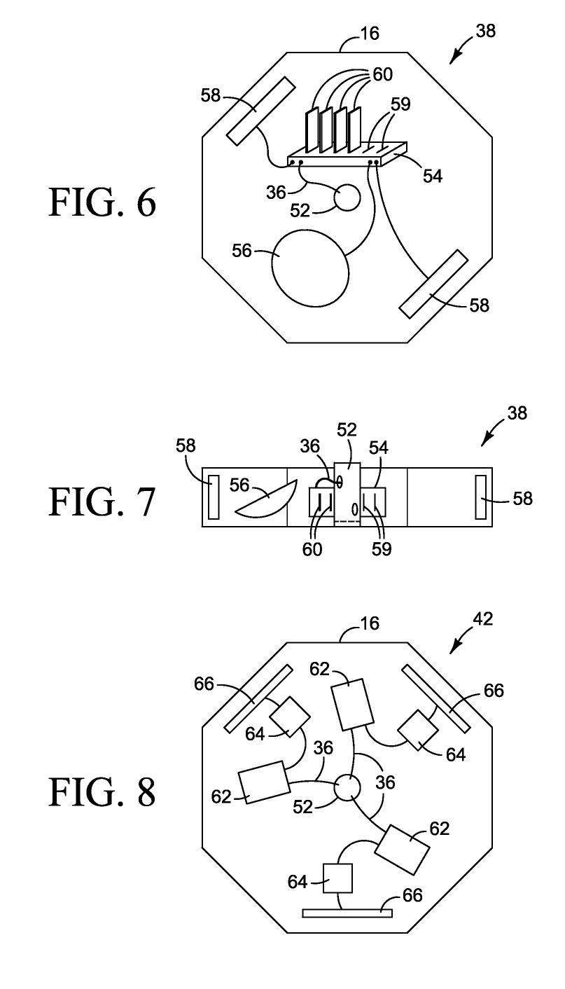

An embodiment of a provisioning module 38 is shown in FIG. 6, a plan view, and FIG. 7, a side view. In FIG. 6, provisioning module 38 includes a housing 16 containing a conduit 52. In some embodiments, for each of the modules 12 shown in FIGS. 1 and 5-14, housing 16 and conduit 52 interlock with housing 16 and conduit 52 of an adjacent module. In some embodiments, segments of bus 36 are attached to conduit 52 so that segments of bus 36 connect when modules are interlocked. In some embodiments, bus 36 passes through conduit 52. While conduit 52 is depicted as a simple tube, conduit 52 may have additional structure and a mechanism to interlock the modules and connect segments of bus 36. In FIGS. 6-14, the planform of the modules is shown as an octagon; however, other shapes are usable. Also, while the location of bus 36 and conduit 52 are shown in the center of each module; they may be located to one side, so that modules may be attached to bus 36 by inserting the module laterally, similar to the arrangement used in electronic card cages.

Provisioning module 38 may also include a card adapter 54, a satellite antenna 56, and one or more cell phone antennae 58. Bus 36 connects to card adapter 54. Card adapter 54 has one or more card slots 59 configured to accept one or more cell phone service cards 60. Satellite transceiver circuitry may be included in card adapter 54 or integrated with satellite antenna 56. Cell phone transceiver circuitry may be included in card adapter 54, integrated with cell phone antenna 58, or integrated in each service card 60. The transmit power and antenna pattern of each antenna 58 may be adjusted to fit local conditions, including topography and obstructions, and to provide coverage over a precisely limited area.

To adapt provisioning module 38 to serve a particular site, an operator selects the cell phone services that will be provided at the particular site, and installs a corresponding service card 60 for each service, a process called “provisioning.” Provisioning includes providing service for a set of cell phones conforming to one or more particular published communication standards, or one or more standards unique to a proprietary cell phone network, or both. In operation, cell phone connections are made via a cell phone antenna 58 and the service card 60 corresponding to the user's cell phone. In some circumstances, the cell phone traffic is routed to satellite antenna 56, which then sends it to a common carrier via a communications satellite as described above in FIG. 3. Calls employing different services may be aggregated to a single satellite or terrestrial connection and a single common carrier. In other circumstances, the cell phone traffic is transmitted over bus 36 and a wired connection to a common carrier. Selection of the communications connection depends on cost, the throughput required, and the presence of the connection. For example, in some locations, wired connectivity will not be available, making satellite connectivity the best connection. In other locations, neither satellite nor wired connectivity will be available, requiring the beehive to bridge to another beehive in the network, where the traffic can be forwarded to a satellite or wired connection. In some embodiments, beehive 10 can detect the presence or absence of each connection and select one or more connections among any connections present. In some embodiments, beehive 10 can also select the lowest cost connection among the present connections. Similarly, in some embodiments, beehive 10 may select one or more connections based on the throughput required.

FIG. 8 is a plan view of an embodiment of network access module 42. Network access module 42 provides services connecting mobile wireless devices to one or more networks, including local area networks, wide area networks, and the Internet. Network access module 42 includes one or more network access point circuits 62, each connected to a signal amplifier 64, which is in turn connected to a network antenna 66. Each access point circuit 62 is connected to bus 36. Each interconnected assembly of access point circuit 62, signal amplifier 64, and antenna 66, called an access point assembly, may be used to serve a set of mobile wireless users. The use of multiple access point assemblies allows segmentation of users by geographic location, service type, or user cohort. Service types include, without limitation, Wi-Fi®, Wi-Max®, Bluetooth®, HomeRF®, and HyperLAN®. While access point circuits 62, signal amplifier 64, and antenna 66 are shown as separate components, they may be integrated into one or more combined components for ease of assembly and to reduce cost.

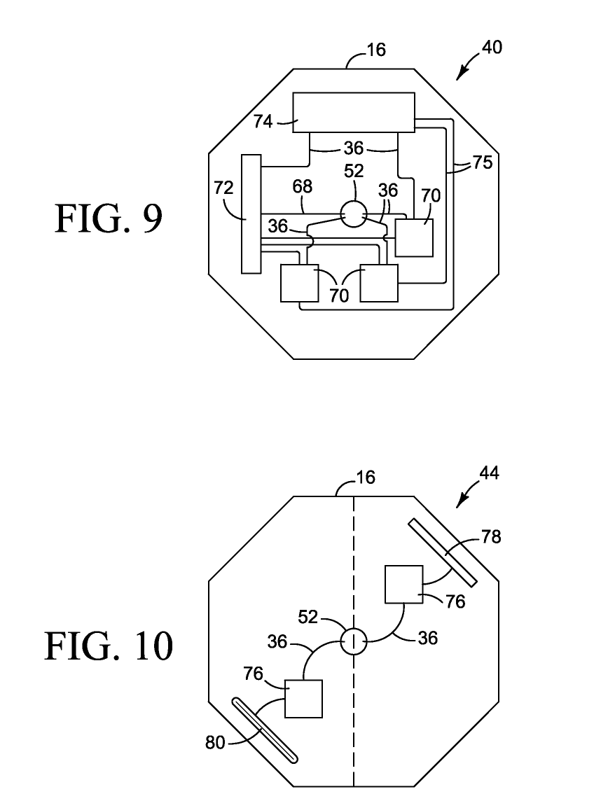

FIG. 9 is a plan view of an embodiment of power module 40. In this embodiment, electrical power enters the module through a power line 68, which may be connected to a city power grid via a utility pole, lamp post, building or other structure on which beehive 10 is mounted. Power is stored by one or more storage units 72 and conditioned by one or more power conditioning units 70. Power conditioning is the minimizing of voltage or current irregularities, and may include one or more of voltage regulation, current regulation, or surge protection. A common form of power conditioning unit is an uninterruptible power supply. Conditioned power is distributed to other modules via bus 36. Power management unit 74 controls power entering power module 40 and power distributed to other modules via one or more signal lines 75 to storage units 72 and power conditioning units 70. Storage unit 72 may include one or more electrical storage batteries, capacitors, inductors or other energy storage devices.

Power module 40 may also be configured to accept electrical power from wireless sources, including ambient light, the sun, wind, or radio frequency sources such as radar or ambient electromagnetic noise. In some embodiments, solar cells may be attached to housing 16 to provide electrical power.

When power module 40 is connected to electrical power lines, such as the power lines provided by an electric utility, beehive 10 may be configured to communicate voice or data to external agents over the power lines using broadband over power line (“BPL”) techniques. Using BPL, voice or data is carried by superimposing a high frequency carrier signal over the standard 50 Hz or 60 Hz alternating current power transmissions. BPL systems include a draft standard IEEE P1901, and HomePlug® BPL from the Homeplug Powerline Alliance.

FIG. 10 is a plan view of an embodiment of a wireless bridge module 44, used primarily to link beehive 10 to one or more other beehives. For example, in FIG. 3, beehive 10 may be linked to beehive 20 via a wireless bridge. Referring to FIG. 10, wireless bridge module 44 includes one or more bridge circuits 76, each connected to one or more bridge antennae 78 and 80. In the embodiment shown, two different types of antennae are used, each chosen to optimize signal quality over a defined geographic area and frequency. Multiple antennae and bridge circuits may be used to achieve the desired signal coverage. Bridge circuits 76 receive communication signals from bridge antennae 78 and 80 and route the signals to another module in the same beehive, or to another beehive, according to the ultimate destination of the communication. Bridge circuits 76 are not limited to bridging identical networks; for example, communications from a Wi-Fi® user may be received at a first beehive 10 by a network access module 42, conducted to a first bridge module 44 via bus 36, wirelessly bridged to a second bridge module 44 installed in a second beehive 10, where it is forwarded to a provisioning module 38 via an internal bus 36, thence to a communications satellite, and thence to the Internet. Wireless bridge module 44 may be also used to communicate between beehives at each node of a network as shown in FIG. 2. A network of bridged beehives 10 (see e.g., FIG. 4) having multiple connections to one or more telecommunications carriers may engage in load balancing, where communications may be routed away from expensive connections or connections nearing capacity, to less expensive connections or lightly loaded connections.

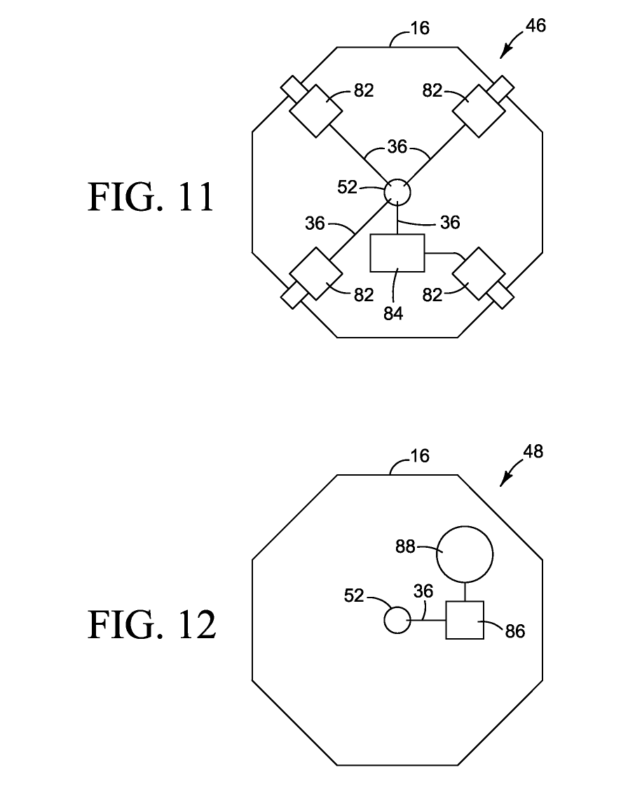

FIG. 11 shows an embodiment of a monitor module 46 employing one or more cameras 82. Cameras 82 may be connected directly to bus 36. Cameras 82 may be of several types, including without limitation, video cameras, still digital cameras, and cameras capable of digital spectrum analysis. In some embodiments, cameras 82 are connected directly to an Ethernet connection and receive power over the Ethernet cable; a type of camera is commonly called a Web cam. Cameras may be useful for security, traffic, weather conditions, road conditions and law enforcement related monitoring. Selected beehives deployed in a network may be fitted with a monitoring module, which may use the beehive network to communicate with a central monitoring agency.

Digital spectrum analysis operates by determining the spectral signature of materials viewed by a camera. The spectrum depends on the composition and molecular structure of the material, and the spectral signature is unique to each material. Digital processing is used to separate the signature of the target material from the image background, and the amount and type of processing depends in part on the spectral and spatial resolution of the image. In some embodiments, the target spectrum is compared to a digital library of spectral signatures to determine the best match to a target material. The digital library may be stored within beehive 10, or image data may be sent to a central location for analysis.

Cameras supporting digital spectrum analysis may contain multi-spectral sensors imaging several hundred spectral bands. Several variables, including spatial resolution and spectral resolution, may be controlled by the user to control the speed and digital processing required to analyze images acquired by camera 82.

Cameras supporting digital spectrum analysis may be used to detect particular materials, such as explosives or particular fabrics, for security or marketing uses. For example, a marketing agency may use a camera 82 installed in monitor module 46 to gather data on how often users wearing a particular fabric pass by a beehive site on a busy street.

Cameras 82 may be used in conjunction image analysis software to detect particular features, such as signs or faces. For example, security personnel may use monitor module 46 to search for the face of a particular criminal. Cameras combined with image analysis and external triggering may be used to enhance the security and security tracking of an area or near-by building. External triggering includes the use of sensors such as infrared or ultrasonic motion detectors, sound detectors, light detectors, window sensors, and door sensors to trigger an alarm or notify security personnel of an event. These sensors may be mounted on monitor module 46 or mounted remotely, with wired or wireless communication between monitor module 46 and the remote sensor. The beehive may also contain modules or parts of modules that further enhance security by taking a more active role. Such features may include a tagging system to mark vehicles or people, or immobilization systems such as bright lights or tasers to slow or detain assailants or vehicles.

In a related security application, beehive 10 may also contain modules or part of modules that further enhance security by taking a more active role. Such features may include a tagging system to mark vehicles or people, or immobilization systems such as bright lights or tasers to slow or detain assailants or vehicles.

Monitor module 46 is not limited to security sensors and cameras; rather, monitor module 46 may be configured with sensors to monitor a variety of physical phenomena, including weather, air quality, light, and sound. Weather monitoring may include, without limitation, internal or ambient air temperature, wind speed, humidity, cloud cover, lightning, and atmospheric pressure. Air quality monitoring may include, without limitation, monitoring the presence of pollutants, particulates, allergens, gases, biological weapons, chemical weapons, automobile emissions, and industrial emissions, and may be particularly useful where beehives are deployed in a metropolitan area network. Similarly, sound monitoring may be used to detect the presence of gunfire, explosions or oral requests for assistance. In some embodiments, one or more sensors, such as cameras 82 or microphones, may be connected to monitoring unit 84, which employs computers or other electronic circuits to detect and communicate the presence of particular physical events, such as, by way of illustration, traffic accidents, crimes, facial recognition, icy roads or gunfire. Monitoring unit 84 may include digital signal processing software or circuitry or image analysis software or circuitry.

FIG. 12 is a plan view of an embodiment of position module 48 employing GPS to determine location information. Position module 48 includes a GPS receiver 86 and a GPS antenna 88. GPS signals are received by GPS antenna 88 and are processed by GPS receiver 86 to determine the position of the beehive 10 in which position module 48 is installed. Position information may be useful to inform beehive network administrators of the position of beehive 10, allowing relatively untrained installers to physically install beehive 10 without making a precise determination of its final location. Position information may also be transmitted to mobile users of beehive services. For example, a laptop or cell phone user may query position module 48 for its position, determining the user's position within an area within the range of beehive 10 and module 48.

Position information, the results of physical phenomena monitoring, public service information, beehive status information, network status information, prices, information related to the installation, status, or use of beehive 10 or a beehive network, or other information of public interest may be presented by a web page associated with beehive 10 and accessible by a universal resource locator (“URL”), and hosted either by any beehive module 12 or by an external host. The web page may be accessible using communication services provided by beehive 10, including, without limitation, Wi-Fi® or Bluetooth®.

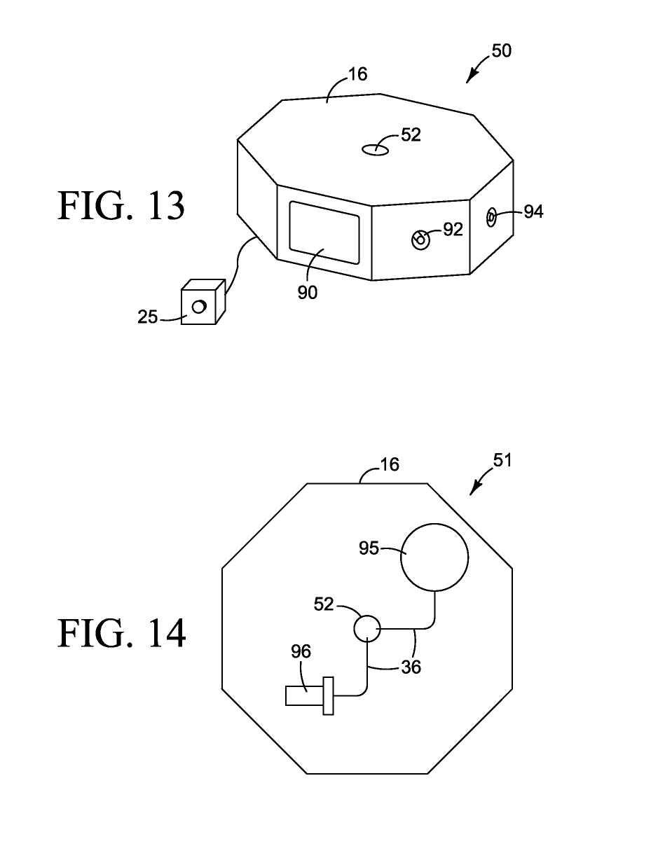

FIG. 13 is a perspective view of an embodiment of multimedia module 50 for communicating audio or visual information. Multimedia encompasses audio media including speech or music, visual media, or both audio and visual media together. In some embodiments, multimedia module 50 may include one or more visual displays 90, speakers 92 and microphones 94. Suitable displays include, without limitation, video displays, arrays of individual lights such as light emitting diode, and projectors. Projectors may be used to display an image on an adjacent surface, such as the side of a building, or in dust or vapors in the air. Suitable projectors include, without limitation, video projectors and steerable lasers, including single and multi-beam lasers. Display 90 may be used to broadcast public announcements, such as advertisements; group announcements; or data intended for a single user, such as email text.

Multimedia module 50 may also perform public services, and may be connected to one or more call boxes 25 containing a button or other sensor allowing a person to request the attention of emergency or service personnel. The connection to call box 25 may be wired or wireless. Emergency or service personnel may use speaker 92 and microphone 94 to communicate with the user; for example, to determine whether to dispatch an emergency team to the site. Also, multimedia module 50 may include a wired external communications link for use emergency personnel at the site. For example, a heart monitor may be connected to multimedia module 50 to communicate a patient's condition to hospital staff. Speaker 92 may also be used to broadcast public announcements or group announcements. Similarly, these features may be used to enhance the security and security tracking of an area or near-by building.

In another embodiment, beehive 10 may communicate using detached visual displays, speakers, or microphones, which are separately mounted in the local region to extend the visual reach of the beehive 10. In an illustrative application, such displays or speakers may be used to transmit the message of, for example, one or more political candidates. As the candidate moves through an area served by a beehive network 33, a beehive may detect the candidate's presence using image detection techniques (by monitor module 46), or by detecting the presence of a wireless computing device (by network access module 42). When a candidate is nearby a particular beehive 10, it displays the candidate's message on display 90 (multimedia module 50) and on nearby, separately mounted displays. The effect is of a traveling advertising message that remains synchronized with the candidate as they travel through the area serviced by a beehive network 33.

FIG. 14 is a plan view of an embodiment of data storage module 51, including one or more disk drives 95, or one or more solid state storage media 96. An entity may lease storage space on data storage module 51, or make use of a network of these data storage mechanisms. A portion of the storage capacity may also be made available to the public either as a public service for public information, or may be made generally available to the local public in a particular area as part of the hosting agreement with the local government.

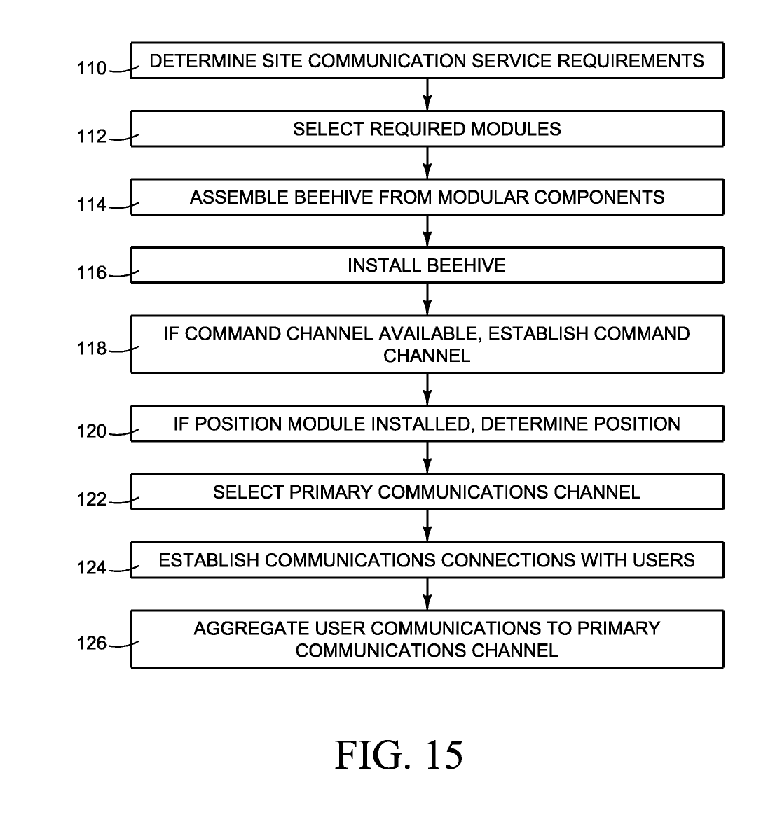

Embodiments of beehive 10 provide considerable flexibility when defining and installing a network. To illustrate, a network designer may match beehive modules 10 to requirements: perhaps having provisioning module 38, a power module 40, multiple network access modules 42 and a bridge module 44 in a first location, and having a provisioning module 38, a power module 40, a bridge module 44, multiple multimedia module 50 in another location. Referring to FIG. 15, a flowchart illustrating an exemplary process for installing a beehive, an installer must first determine site communication services requirements in step 110. This determination includes, without limitation, determining the types of wireless services that potential users will require, the desired geographic coverage; the availability of electrical power; the availability of fixed rigid structures, such as lamp posts and buildings; and the presence of large objects or terrain that would interfere with the signal. An installer will use this information to select the appropriate modules in step 112, to build up a beehive in step 114. The installer may connect modules together to build a beehive, or may modify an existing beehive by installing or removing modules. The installer may then install the beehive by attaching to a rigid structure and attach wiring to electrical power, if available, and turn on the beehive in step 116. Because of the modular nature and small size in some embodiments, steps 110 through 116 may be performed by a relatively untrained installer in a truck, or similar service vehicle, parked near the installation site. The beehive may find and establish a command channel, if available, in step 118. The command channel may be used to report position information to a central network administrator, and to configure the beehive. The beehive may determine its position in step 120, if a position module or position sensing circuitry in another module is installed. The beehive may establish a primary communications channel in step 122. In this context, a primary communications channel is used to carry data from users of wireless services provided by this beehive to a telecommunications carrier, other network or another beehive. For example, the primary communications channel may be, without limitation, a connection to a communications satellite, a wired connection to the Internet, or a wireless bridge connection to another beehive in a beehive network. The beehive establishes communications with service users in step 124, and aggregates user communications to the primary communications channel in step 126.

Skilled artisans will recognize that the functions of modules may be combined or exchanged. For example, multimedia module 50 according to the embodiment shown in FIG. 13 includes a microphone 94, and may perform the sound monitoring function described for the monitor module 46. In another embodiment, one or more monitoring functions may be combined with the multimedia module 50. In addition, new modules may be developed as new user service requirements arise. The modular design of beehive 10 allows new modules to be designed and attached to beehive 10 either before installation at a site, or added to an existing beehive 10 after initial installation.

When functions are combined, it may be necessary to divide a module into multiple compartments, to physically and electrically isolate the components associated with different functions. The compartments may be of variable size so that customization may be performed in the field. Furthermore, the compartments may be electromagnetically shielded using techniques well known in the art, depending on the requirements of its internal components.

From the foregoing, it will be appreciated that the network device and network provided by the invention provides a significant advance in the art of providing wireless communication services.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

What is claimed is:

1. A modular device for wireless communications, comprising:
a first module capable of communicating wirelessly to an electronic device;
at least one second module, wherein said second module is:
a provisioning module capable of wirelessly communicating with one or more subscriber units;
a power module capable of providing electrical power to said modular device, wherein said power module comprises a battery for storing electrical energy and an electronic circuit for conditioning the voltage and current;
a bridge module capable of communicating with another said modular device, wherein said bridge module communicates wirelessly, wherein said bridge module communicates via an electrical conductor, wherein said electrical conductor is selected from the group consisting of an electric power line, a fiber optic cable, a coaxial cable, a telephone line, and a dedicated electrical conductor;
a network access module;
a monitor module capable of monitoring at least one physical phenomenon, wherein said monitor module comprises a camera;
a position module capable of determining the location of said modular device, wherein said position module determines the location of said modular device by using a satellite navigation system;
a data storage module capable of storing digital data for later retrieval;
a multimedia module capable of presenting audiovisual information; and
a bus providing data communication and power transmission between said second module and said first module.
